(19) United States
(12) Patent Application Publication
(10) Pub. No.: US 2005/0052404 A1
(43) Pub. Date: Mar. 10, 2005

(54) Rotational information display device capable of connecting to personal computer

(76) Inventors: Seongukk Kim, Seoul (KR); Hyewon Baek, Seoul (KR); Sean Lee, Huntington, NY (US)

Correspondence Address: WELLS ST. JOHN P.S., 601 W. FIRST AVENUE, SUITE 1300, SPOKANE, WA, 99201, US

(21) Appl. No.: 10/660,423

(22) Filed: Sep. 10, 2003

(51) Int. Cl. G09G 3/34

(52) U.S. Cl. 345/108

(57) ABSTRACT

A rotational information display device capable of connecting a personal computer outputs a connection status of a messenger, the connection with a friend set by the user, a messenger change status of the mail receiver or the content of a personal alarm set or the like as a three dimensional image, a graphic image, a character, an audio signal or the like through the rotational information display device. Therefore, the rotational information display device increases the utilization therefore since a connection status, the connection with a friend set by the user, a messenger change status of the mail receiver or the content of a personal alarm set is identified by using a three dimensional image, a graphic image, a character, an audio signal or the like although the users of the personal computers do not use their computers. Also, by transmitting a messenger change status of a personal alarm setting content inputted from a personal computer in a wireless communication member of the rotational information display device through a wireless communication system utilizing a plurality of infrared ray sensors when the inputted data are transmitted to a control member installed on a rotational frame, a structure of the printed circuit board is simplified, thereby drastically improving the efficiency of work.

### FIELD OF THE INVENTION

The present invention relates to a rotational information display device; and, more particularly, to a rotational information display device capable of connecting to a personal computer so as to output a connection status of messenger installed on the personal computer, the connection with a friend set by the user, a messenger change status of the mail receiver or the content of a personal alarm set as a three dimensional image, a graphic image, a character, an audio signal or the like through the rotational information display device connected to the personal computer.

### DESCRIPTION OF RELATED ART

In general, among effects related to the light sense of the human, an afterimage effect means a visual memory effect which causes an illusion as a real image exists during a predetermined time period with remaining the previously fading image as an afterimage.

Recently, a rotational information display device has been developed for displaying a three dimensional information in an atmospheric space by rotating a light source such as a light emitting device (LED) by using the afterimage effect described above, thereby utilizing for a commercial advertisement.

Referring to FIG. 1, there is shown a diagram showing a conventional rotational information display device.

As shown in FIG. 1, the rotational information display device according to a prior art has a housing 1, a motor 2 installed in the housing 1 and rotationally driven by a commercial power supplied from outside and a rotational frame 3 mounted on a rotational axis 2a of the motor 2 with cooperating with the rotational drive of the motor 2.

At this time, the above-described rotational frame 3 has a first light emitting material supporting member 5 so as to implement an information display surface of a spherical shape by placing a light emitting diode (LED) 4 in the form of an arch during the rotation, a second light emitting material supporting member 6 so as to implement a cylindrical information display surface in the form of a strip at the bottom side of the spherical shape information display surface by placing at the opposite side of the first light emitting material supporting member 5 with spacing apart by a predetermined distance from the rotational axis 2a and by arranging the LED 4 in a straight line and a third light emitting material supporting member 7 so as to implement the cylindrical information display surface in the form of a strip at the inside of the spherical shape display surface by arranging the LED 4 between the first and the second light emitting material supporting members 5 and 6 in a straight line during the rotation.

The driving operation of the rotational information display device according to the prior art constructed as described above as follows.

First of all, if an external commercial power is supplied to the rotational information display device, the LEDs 4 respectively mounted on each of the first to third light emitting material supporting member 5, 6 and 7 are operated.

And then, when the motor 2 is operated, the rotational frame 3 mounted on the rotational axis 2a of the motor 2 starts to rotate and the three dimensional information is displayed on the atmospheric space by the LEDs 4 arranged respectively on each of the first to the third light emitting material supporting member 5, 6 and 7 in response to the high speed rotation of the rotational frame 3.

According to this, the users identify the commercial advertisement through the three dimensional solid image outputted from the rotational information display device.

However, since the rotational information display device according to the prior art utilizes a light-emitting device with a single color, it is impossible to implement a three dimensional solid shape near to a natural color, a graphic image, a character or the like. And, since a high power output is used for rotating the rotating frame in a high speed, the conventional rotational information device has a problem that a safety accident very frequently occurs when the users are contact to the portion of the rotational framed during the rotation in a high speed.

### SUMMARY OF THE INVENTION

It is, therefore, an object of the present invention to provide solve the above-described problems of the conventional method and to provide a rotational information display device capable of connecting a personal computer for outputting a connection status of a messenger installed on a personal computer with connecting to the rotational information display device, the connection with a friend set by the user, a messenger change status of the mail receiver or the content of a personal alarm set or the like as a three dimensional image, a graphic image, a character, an audio signal or the like through the rotational information display device.

Another object of the present invention is provided to a rotational information display device capable of connecting a personal computer for outputting a connection status of a messenger installed on a personal computer with connecting to the rotational information display device, the connection with a friend set by the user, a messenger change status of the mail receiver or the content of a personal alarm set or the like as a three dimensional image, a graphic image, a character, an audio signal or the like by transmitting the data inputted from the personal computer to a control member of the rotational information display device through a wireless communication by providing a plurality of infrared ray sensors on the rotational information display device connected to the personal computer.

Still another object of the present invention is provided to a rotational information display device capable of connecting a personal computer for freely realizing a three dimensional image, a graphic image and a character similar to a natural color by utilizing a plurality of surface mount device light emitting diodes capable of combining three primary colors (R, G and B) in place of a light source with a single color light emitting diodes utilized in the rotational information display device.

Further another object of the present invention is provided to a rotational information display device capable of connecting a personal computer for providing a safety to the user by automatically stopping the rotational information display device without increasing the rotational power of the rotational information display device connected to the personal computer when the contact is occurred by the user during the rotational operation.

In accordance with one aspect of the present invention,

there is provided a rotational information display device provided with a housing, a motor installed in the housing and rotationally driven by a commercial power supplied from outside, a rotational frame (a control printed circuit board) mounted on a rotational axis of the motor with cooperating with the rotational drive of the motor and a plurality of single color light emitting diodes mounted on the rotational frame for displaying a three dimensional image and character in response to an afterimage effect during the rotation of the rotational frame, which comprises: a personal computer connection means connected to a personal computer by forming on a bottom portion of the housing for receiving a messenger change status or data for a personal alarm set content from the personal computer; a wireless communication means for processing so as to transmit the messenger change status or the data for the personal alarm set content inputted from the personal computer through the personal computer connection means to a control means through a wireless communication; a control means provided on the rotational frame for controlling outputs of a three dimensional solid shape and a graphic image or a character based on the messenger change status or the data for the personal alarm set content inputted from the personal computer through the personal computer connection means through the wireless communication means; a storage means provided on the rotational frame for temporally storing the messenger change status or the data for the personal alarm set content transmitted from the wireless communication means in response to the control of the control means; a three dimensional representation means, provided thereon a plurality of light sources arranged in the form of arch so as to perform a three dimensional spherical shape of information display during the rotation, for displaying a three dimensional solid shape to the messenger change status or the data for the personal alarm set content transmitted from the personal computer in response to the control of the control means; a image/character representation means, provided thereon a plurality of light sources arranged in the form of a straight line, for displaying a graphic image or character to the messenger change status or the data for the personal alarm set content transmitted from the personal computer in response to the control of the control means; a voice output means for amplifying a voice signal related to the messenger change status or the data for the personal alarm set content outputted from a speaker terminal of the personal computer formed on a bottom portion of the housing with connecting to a speaker jack; and a power supply printed circuit board formed between a top portion of the motor and the rotational frame, provided with the wireless communication means and the voice output means, for supplying an external commercial power applied from a power jack provided on the bottom portion of the housing to said each means.

In accordance with another aspect of the present invention, there is provided a rotational information display device, wherein the personal computer connection means includes a universal serial bus (USB) port.

In accordance with another aspect of the present invention, there is provided a rotational information display device, wherein the personal computer connection means includes IEEE1394 port.

In accordance with another aspect of the present invention, there is provided a rotational information display device, wherein the plurality of light sources incorporated into the three dimensional representation means and the image/character representation means includes are a plurality of surface mount device (SMD) light emitting diodes capable of combining three primary colors (R, G and B).

In accordance with another aspect of the present invention, there is provided a rotational information display device, wherein an image is displayed on the top ⅔ portions of the image/character representation means and a character is displayed on the remaining bottom ⅓ portion of the image/character representation means.

In accordance with another aspect of the present invention, there is provided a rotational information display device, wherein the plurality of light sources incorporated into the image/character representation means displays an e-mail notice, a user's alarm setting or a timer setting content of the personal computer inputted through the personal computer connection means through an image or a character.

In accordance with another aspect of the present invention, there is provided a rotational information display device, wherein the wireless communication means includes: a plurality of transmitting infrared ray sensors installed on a top portion of the power supply printed circuit board for transmitting data related to the messenger change status or the data for the personal alarm set content transmitted from the personal computer through the personal connection means; and at least one receiving infrared ray sensor, installed on a bottom portion of the rotational frame, for receiving the messenger change status or the data for the personal alarm set content transmitted from the plurality of transmitting infrared ray sensors and for outputting the received data to the control means.

In accordance with another aspect of the present invention, there is provided a rotational information display device, wherein the plurality of transmitting infrared ray sensors is arranged on a top portion of the power supply printed circuit board in the form of circle by an equal distance in response to a rotational orbit of the receiving infrared ray sensor.

### BRIEF DESCRIPTION OF THE DRAWINGS

The above and other objects and features of the instant invention will become apparent from the following description of preferred embodiments taken in conjunction with the accompanying drawings, in which:

FIG. 1 is a diagram showing a conventional rotational information display device;

FIG. 2 shows a schematic block diagram representing the configuration of a rotational information display device capable of connecting to a personal computer in accordance with a preferred embodiment of the present invention;

FIG. 3a and FIG. 3b illustrate perspective diagrams depicting the rotational information display device capable of connecting to the personal computer in accordance with the present invention;

FIG. 4 is a schematic cross sectional view of the rotational information display device capable of connecting to the personal computer shown in FIG. 3b; and

FIG. 5 is a flow chart describing in detail the operational process of the rotational information display device capable of connecting to the personal computer in accordance with a preferred embodiment of the present invention.

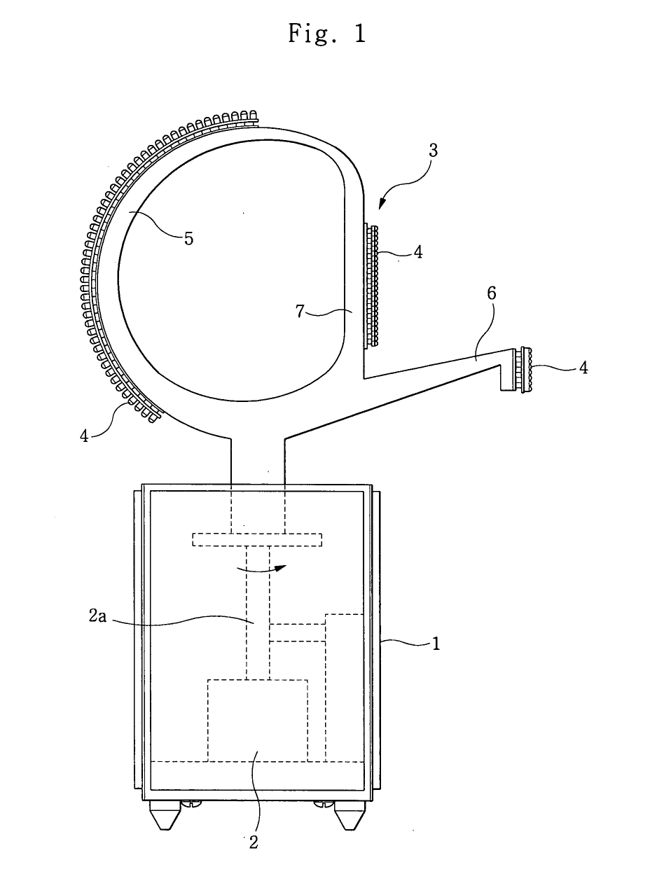

### DETAILED DESCRIPTION OF THE INVENTION

Hereinafter, a preferred embodiment of the present invention will be described in detail referring to the accompanying drawings.

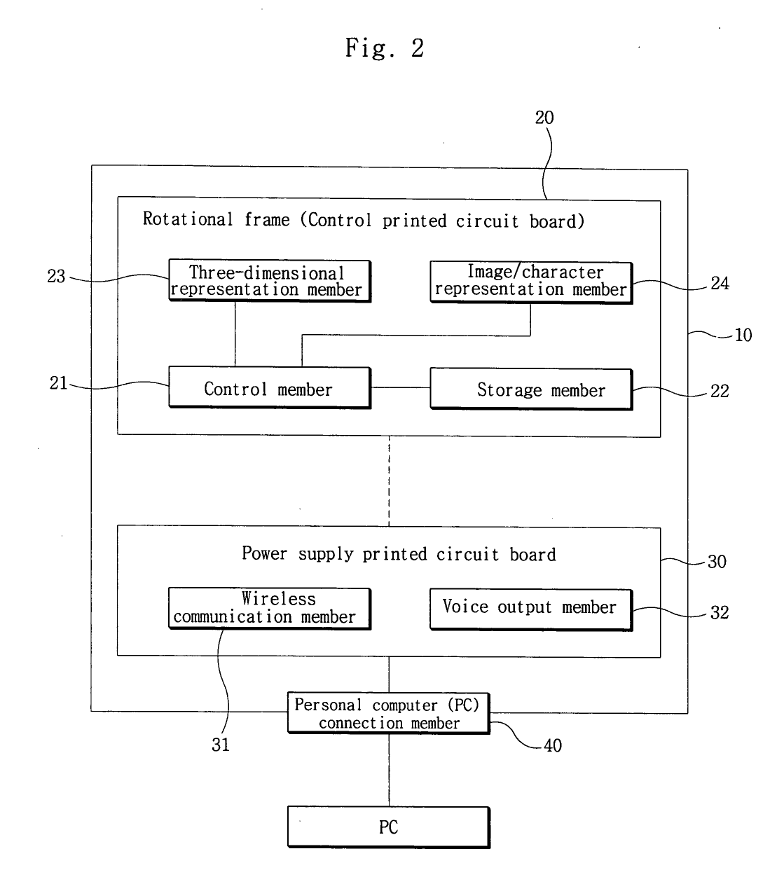

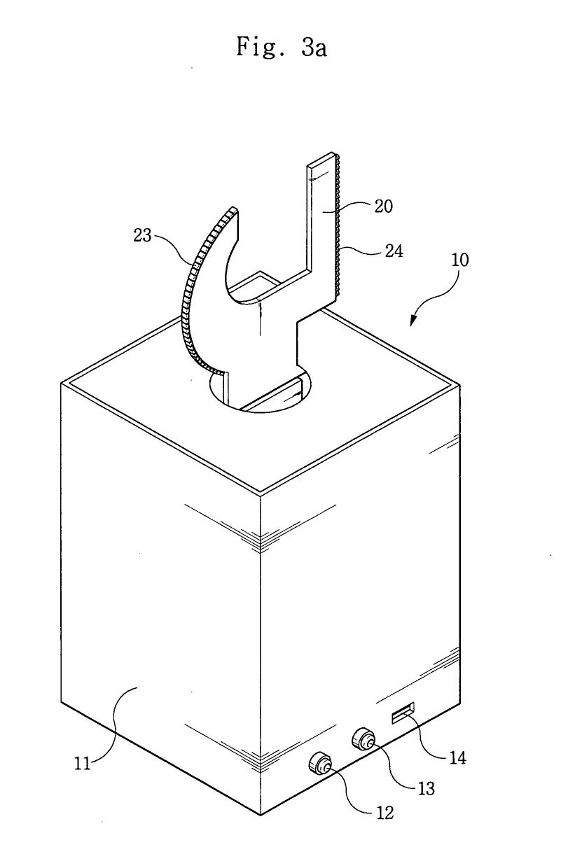

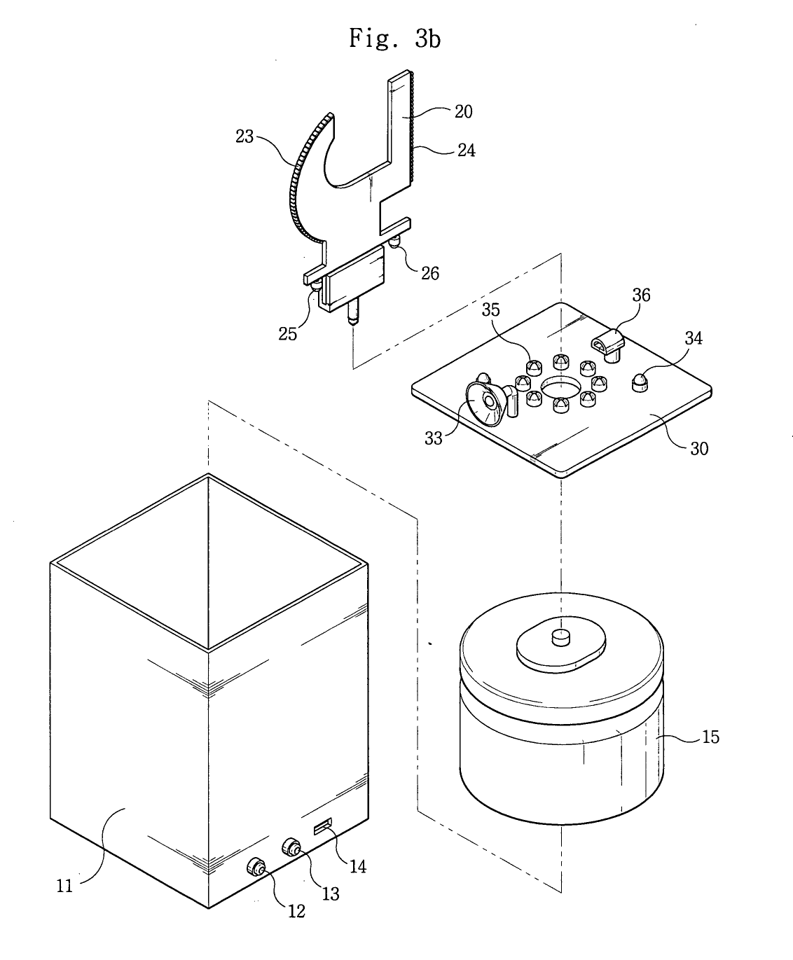

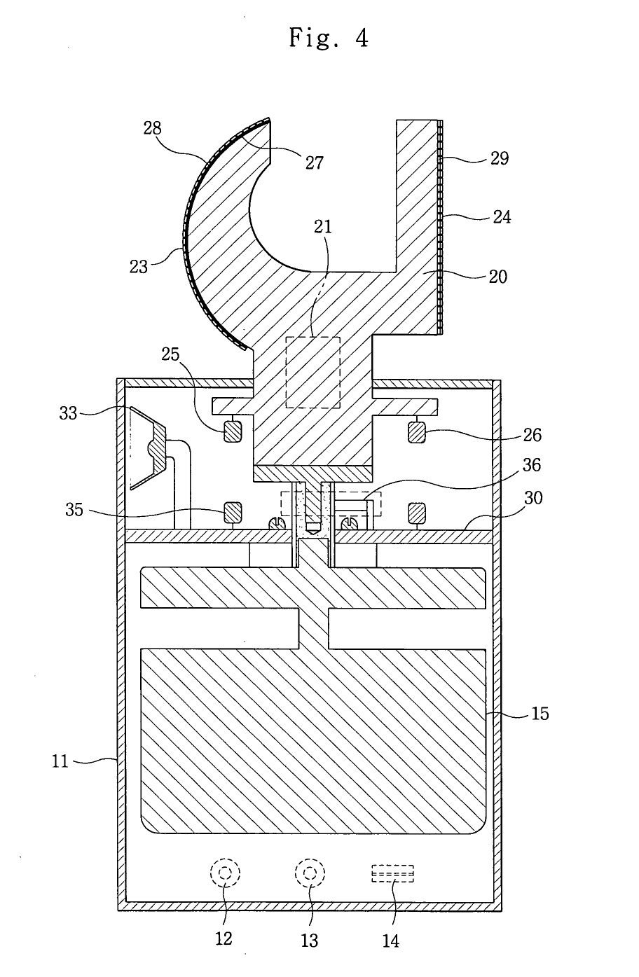

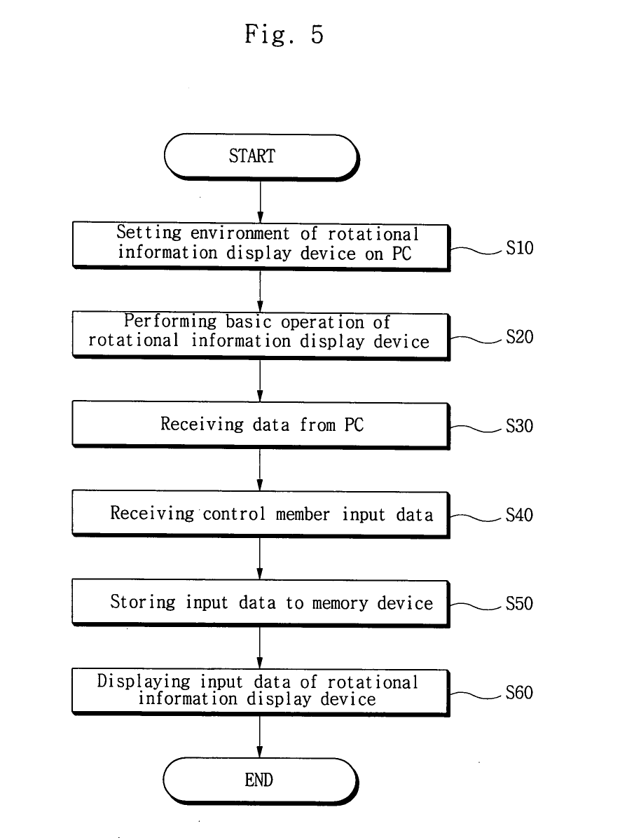

FIG. 2 shows a schematic block diagram representing the configuration of a rotational information display device capable of connecting to a personal computer in accordance with a preferred embodiment of the present invention; FIG. 3a and FIG. 3b illustrate perspective diagrams depicting the rotational information display device capable of connecting to the personal computer in accordance with the present invention; FIG. 4 is a schematic cross sectional view of the rotational information display device capable of connecting to the personal computer shown in FIG. 3b; and FIG. 5 is a flow chart describing in detail the operational process of the rotational information display device capable of connecting to the personal computer in accordance with a preferred embodiment of the present invention.

Hereinafter, the rotational information display device capable of connecting to the personal computer in accordance with a preferred embodiment of the present invention is explained in detail referring to the accompanying drawings.

FIG. 2 shows a schematic block diagram representing the configuration of a rotational information display device 10 capable of connecting to a personal computer in accordance with a preferred embodiment of the present invention. The rotational information display device 10 is connected to an external computer through a personal computer (PC) connection member 40, receives an image or a character data from the external computer and displays the received image or data through a three dimensional representation member 23 and an image/character representation member 24.

The data inputted through the PC connection member 40 is transmitted to the power supply printed circuit board 30. A voice data among the inputted data is transmitted to the voice output member 32, thereby guiding the user in voice. And, the character or the image data is transmitted to a wireless communication member 31 and transmitted to a rotational frame (a control printed circuit board) 20 by means of an infrared ray transmission/reception method. By the control of a control member 21, a storage member 22 stores the wirelessly received data, and the three-dimensional representation member 23 and the image/character representation member 24 displays the received data as a graphic solid data to transmit to the uses.

FIG. 3a and FIG. 3b illustrate perspective diagrams depicting the rotational information display device capable of connecting to the personal computer in accordance with the present invention. FIG. 3a depicts the configuration of the external appearance of the rotational information display device 10. The three-dimensional representation member 23 and the image/character representation member 24 display the various received data through the personal computer in response to the rotational operation of the rotational frame 20 placed at the top portion of the housing 11. The inputted data includes the data displayed during a constant rotation, the data for informing the reception of the e-mail of the user, the alarm of user or a temporal data informing in response to the timer setting or the like.

The external power is supplied by placing a power jack 12 for driving the rotational information display device 10 at a predetermined position of the bottom portion of the housing 11. And also, a speaker jack 13 receives a voice data from the personal computer. And, the image/character data to be displayed at the rotational information display device 10 is inputted from the external personal computer through a universal serial bus (USB) port 14. In addition, the above-described USB port 14 is capable of replacing with IEEE1394 port and allowing the configuration thereof to be changed in response to the communication method connected the external device of the current computer.

FIG. 3b shows the separated structure state of the rotational information display device 10 as shown in FIG. 3a. The power inputted through the power jack 12 drives the motor 15, the power supply printed circuit board 30 is placed on the top portion of the motor 15 and the rotational frame 20 is cooperated in response to the rotation of the motor 15.

As being an infrared communication implementation method of a rotational information display device, a plurality of bottom side transmitting infrared ray sensors 35 on the power supply printed circuit board 30 is arranged with describing an orbit in the form of circle and a top side receiving infrared ray sensor 25 is fixed to a rotational frame 20 to be rotate.

The plurality of bottom side transmitting infrared ray sensors 35 sends data simultaneously and the top side receiving infrared ray sensor 25 can receive data at any angle without occurring an error. Specifically, the plurality of bottom side transmitting infrared ray sensors 35 transmits only simple signal not being a modulation method, the transmitted signal is reflected by controlling the gain value and only the opposite receiving infrared sensor receives the data corresponding to the signal being no interference with the other receiving infrared sensor 25.

FIG. 4 is a schematic cross sectional view of the rotational information display device capable of connecting to the personal computer shown in FIG. 3b.

The three-dimensional representation member 23, formed on the rotational frame 20 as a top side rotational body, is made of a structure capable of shaping in a circular symmetry during the rotation and the plurality of LEDs 28 is mounted on the surface of the three-dimensional representation member 23 in a surface mounted device (SMD) type having a small size. In this result, it compensates the shortcomings of the conventional LED and the mounting structure also provides a convenience of the mass production. And also, it has an advantage that the control gives the reliability to the signal by transmitting the signal to the rotational frame (a control printed circuit board) 20 patterning thereinto the signals of the control device (referring to the reference numerals 20, 23, 27 and 28).

The image/character representation member 24 is represented by a plurality of LEDs 29 arranged in a row of straight line, an image is displayed on the top ⅔ portions and a character is displayed on the remaining bottom ⅓ portion. The image/character representation member 24 has a control and attachment structure similar to the LED 28 of the above-described three-dimensional representation member 23 and has the characteristics to display various contents of characters transmitted from the external computer.

More particularly, the light emitting diode utilized in the rotational information display device in accordance with the preferred embodiment of the present invention applies a plurality of SMD light emitting diode capable of combining the three primary colors (R, G and B) and has the characteristics to implement the solid image similar to the natural color by implementing the 1024 colors by controlling the plurality of SMD light emitting diodes in 10 bits. It is different from the controlling a turn-on or a turn-off at only desired position when a conventional single color type LED is utilized, and it controls the operation thereof by determining the color of the desired position by using the inputted graphic data structure.

The motor 15 corresponding to the driving apparatus incorporating into the inner side of the housing is capable of rotating in a high speed, it is driven by using a compact sized rotational device. Since the rotational force is not enough, the motor 15 is stopped by contacting with any object and rotates the rotational frame 20. And also, the power supplied to the motor 15 is supplied to the blush 36 formed on the power supply printed circuit board 30 and the power is supplied to each of the rotational frames through the blush 36.

The control member 21 controls each operation of the products by determining the data reception status from the external user computer and controls the managing function of the received data with connecting to the memory device. If the regular alarm message assigned by the user through the environmental setting on the PC is inputted through the PC input member, the control member stores the input data on the storage member and allows the data to be displayed by using the control member 21 and the storage member 22 independent with the PC. And also, the data can be displayed whenever the event is occurred from the connected computer.

The rotational information display device 10 is basically positioned at a stop state or a rotation state. And then, whenever the event is occurred from the control member 21 or the external PC, it displays the contents corresponding to the generated event as the character and the image. The types of the events include the status of messenger program such as an email reception notice or an alarm for a promise inputted thereto a determined time by the user and a memo and a timer event.

The PC connection member 40 employs a conventional serial communication method. An infrared ray communication and a wireless communication are adapted as a transmission media with the control member 21, the infrared ray communication with the plurality of bottom side transmitting infrared ray sensors 35 and the top side receiving infrared ray sensor 25 and the wireless communication on the rotational frame 20. Particularly, the infrared ray communication and the wireless communication can be selectively changed by the convenience of the user and the spatial restriction as an optional specification.

The voice output member 32 implements by means of the speaker 33 on the power supply printed circuit board 30. The voice signal inputted through the speaker jack 13 from the external PC is transmitted and outputted to the speaker 33 via an amplification block.

FIG. 5 is a flow chart describing in detail the operational process of the rotational information display device capable of connecting to the personal computer in accordance with a preferred embodiment of the present invention.

In step S10 for setting the environment of a rotational information display device on a PC, a voice and a graphic data for the various notice events are selected after the user confirms the connection status of the rotational information display device on the computer, and the message contents according to the selected result are previously established.

In step S20 for performing a basic operation of the rotational information display device, the rotational information display device performs the basic operations together with the drive of the computer. In the basic operations, a rotational operation for continuously rotating a rotational frame in response to a previously set content and a stop operation.

If a predetermined input event is generated from the PC in the basic operation status, the process is converted into an operation to output in response to the generated result.

In step S30 for receiving the data from the PC, if a predetermined event assigned by the user on the PC is occurred, the data according to the occurred result is inputted through the PC connection member of the rotational information display device.

In step S40 for receiving the control member input data, the input data wirelessly received by the receiving infrared ray sensor is transmitted to the control member.

In step S50 for storing an input data to the memory device, the control member stores a character to be displayed and an image data at the storage member.

In step S60 for displaying an input data of the rotational information display device, if it is passed by a predetermined time, an alarm is automatically operated and the operated alarm is notified to the user by displaying a predetermined character and a graphic message through a three dimensional representation member and an image/character representation member.

The present rotational information display device according to the above-described configuration informs the three-dimensional solid shape, a graphic image, character information and voice information to the user, simultaneously. It is possible that the message format set by the user can be modified with various types.

For example, a notice data such as a network connection status, an e-mail status of a messenger program, other computer messages, an application program start, an end of the notice and the position change of a mouse can be assigned. Therefore, the user can assign the contents of alarm by inputting, correcting and erasing the image or the characters desired for displaying through the environment set and the spherical solid in response to a personal preference type.

In accordance with the above-described present invention of the rotational information display device capable of connecting the personal computer, the utilization of the rotational information display device can be increased since a connection status, the connection with a friend set by the user, a messenger change status of the mail receiver or the content of a personal alarm set or the like can be identified by using a three dimensional image, a graphic image, a character, an audio signal or the like through the rotational information display device connected to the personal computer although the users of the personal computers do not use their computers.

And also, by transmitting a messenger change status of a personal alarm setting content inputted from a personal computer in a wireless communication member of the rotational information display device through a wireless communication system utilizing a plurality of infrared ray sensors when the inputted data are transmitted to a control member installed on a rotational frame (a control printed circuit board), a structure of the printed circuit board utilizing in the rotational information display device can be simplified, thereby drastically improving the efficiency of work.

Further, by directly controlling the color of the desired position by using the graphic data of the personal computer without the concepts of turn-on and turn-off by employing a light source utilized in the rotational information display device as a plurality of SMD light emitting diodes combining three primary colors (R, G and B) not being a single color light emitting diode, 1024 colors are realized, thereby freely implementing a three dimensional solid shape, a graphic image or character similar to a natural color.

Furthermore, since the rotational power of the rotational information display device does not increase highly on the consideration of the safety of the users for using the rotational information display device, the users including children can safely utilize the rotational information display device and previously prevent the generation of safety accidents by automatically stopping the driving of the rotational information display device when the contact caused by the user is occurred during the rotational driving.

While the present invention has been described with respect to the particular embodiments, it will be apparent to those skilled in the art that various changes and modifications may be made without departing from the spirit and scope of the invention as defined in the following claims.

1. A rotational information display device provided with a housing, a motor installed in the housing and rotationally driven by a commercial power supplied from outside, a rotational frame (a control printed circuit board) mounted on a rotational axis of the motor with cooperating with the rotational drive of the motor and a plurality of single color light emitting diodes mounted on the rotational frame for displaying a three dimensional image and character in response to an afterimage effect during the rotation of the rotational frame, which comprises:
a personal computer connection means connected to a personal computer by forming on a bottom portion of the housing for receiving a messenger change status or data for a personal alarm set content from the personal computer;
a wireless communication means for processing so as to transmit the messenger change status or the data for the personal alarm set content inputted from the personal computer through the personal computer connection means to a control means through a wireless communication;
a control means provided on the rotational frame for controlling outputs of a three dimensional solid shape and a graphic image or a character based on the messenger change status or the data for the personal alarm set content inputted from the personal computer through the personal computer connection means through the wireless communication means;
a storage means provided on the rotational frame for temporally storing the messenger change status or the data for the personal alarm set content transmitted from the wireless communication means in response to the control of the control means;
a three dimensional representation means, provided thereon a plurality of light sources arranged in the form of arch so as to perform a three dimensional spherical shape of information display during the rotation, for displaying a three dimensional solid shape to the messenger change status or the data for the personal alarm set content transmitted from the personal computer in response to the control of the control means;
a image/character representation means, provided thereon a plurality of light sources arranged in the form of a straight line, for displaying a graphic image or character to the messenger change status or the data for the personal alarm set content transmitted from the personal computer in response to the control of the control means;
a voice output means for amplifying a voice signal related to the messenger change status or the data for the personal alarm set content outputted from a speaker terminal of the personal computer formed on a bottom portion of the housing with connecting to a speaker jack; and
a power supply printed circuit board formed between a top portion of the motor and the rotational frame, provided with the wireless communication means and the voice output means, for supplying an external commercial power applied from a power jack provided on the bottom portion of the housing to said each means.

2. The rotational information display device of claim 1, wherein the personal computer connection means includes a universal serial bus (USB) port.

3. The rotational information display device of claim 1, wherein the personal computer connection means includes IEEE1394 port.

4. The rotational information display device of claim 1, wherein the plurality of light sources incorporated into the three dimensional representation means and the image/character representation means includes are a plurality of surface mount device (SMD) light emitting diodes capable of combining three primary colors (R, G and B).

5. The rotational information display device of claim 1, wherein an image is displayed on the top ⅔ portions of the image/character representation means and a character is displayed on the remaining bottom ⅓ portion of the image/character representation means.

6. The rotational information display device of claim 1, wherein the plurality of light sources incorporated into the image/character representation means displays an e-mail notice, a user's alarm setting or a timer setting content of the personal computer inputted through the personal computer connection means through an image or a character.

7. The rotational information display device of claim 4, wherein the plurality of light sources incorporated into the image/character representation means displays an e-mail notice, a user's alarm setting or a timer setting content of the personal computer inputted through the personal computer connection means through an image or a character.

8. The rotational information display device of claim 1, wherein the wireless communication means includes:
a plurality of transmitting infrared ray sensors installed on a top portion of the power supply printed circuit board for transmitting data related to the messenger change status or the data for the personal alarm set content transmitted from the personal computer through the personal connection means; and
at least one receiving infrared ray sensor, installed on a bottom portion of the rotational frame, for receiving the messenger change status or the data for the personal alarm set content transmitted from the plurality of transmitting infrared ray sensors and for outputting the received data to the control means.

9. The rotational information display device of claim 6, wherein the plurality of transmitting infrared ray sensors is arranged on a top portion of the power supply printed circuit board in the form of circle by an equal distance in response to a rotational orbit of the receiving infrared ray sensor.

10. The rotational information display device of claim 9, wherein the plurality of transmitting infrared ray sensors is arranged on a top portion of the power supply printed circuit board in the form of circle by an equal distance in response to a rotational orbit of the receiving infrared ray sensor.
